(19) United States
(12) Patent Application Publication
(10) Pub. No.: US 2024/0139914 A1
(43) Pub. Date: May 2, 2024

(54) SOLAR WRENCH

(71) Applicant: Klein Tools, Inc., Lincolnshire, IL (US)

(72) Inventor: Matthew Fuentes, Burleson, TX (US)

(73) Assignee: Klein Tools, Inc., Lincolnshire, IL (US)

(21) Appl. No.: 17/974,777

(22) Filed: Oct. 27, 2022

(51) Int. Cl. B25B 13/08; B25G 1/12

(52) U.S. Cl. CPC B25B 13/08; B25G 1/12

(57) ABSTRACT

An insulated solar wrench includes an elongated body and a pair of prongs at a first end of the elongated body, wherein the prongs are configured to release a first solar connector from a second solar connector. The wrench includes an open-ended wrench at a second end of the elongated body opposite the first end, wherein the open-ended wrench is configured to engage a first portion of the first solar connector. The wrench includes a slot passing through the elongated body and configured to allow a portion of the first solar connector to pass therethrough and engage a second portion of the first solar connector. The elongated body, the pair of prongs, and the open-ended wrench are formed of a metal material, and at least a portion of the metal material of the elongated body, the pair of prongs, and the open-ended wrench is covered by a plastic material.

### BACKGROUND

The present disclosure relates to solar wrenches. Solar wrenches may used, for example, to assemble and/or disassemble solar connectors such as MC4 brand connectors.

As is known in the art, solar wrenches are commonly used to aid in the connecting and/or disconnecting of solar connectors (e.g., MC4 connectors, PV connectors, cable connectors) that are often used in solar panel applications. Solar connectors, (e.g., MC4 connectors) simplify the connection of solar panels and other modules in solar panel applications, allowing for multiple solar panels to be quickly electronically connected by pushing two solar connectors together. Solar connectors, such as MC4 connectors, typically comprise a female end connector at one end of a power cable and a male end connector at an opposite end of the power cable. As is known in the arts, the male end connector is inserted into the female end connector to create a releasable electrical connection. While the design of solar connectors allows for quick and easy connection of male and female connectors by pushing the connectors together, it is oftentimes not desirable to allow the connectors to easily disconnect when the connectors and attached power cable is pulled. Thus, solar connectors typically require a specialized tool such as a solar wrench to release and disconnect the connectors.

Solar wrenches constructed from plastics or metals are known in the art. Plastic solar wrenches may offer an inherently safer design than metallic solar wrenches due to the insulative properties of plastics. However, plastic solar wrenches may lack the strength and durability of those made from metal, leading to increased wear and breakage and reducing the tool life of a plastic solar wrench.

### SUMMARY OF THE DISCLOSURE

In accordance with one feature of this disclosure, an insulated solar wrench is provided and includes an elongated body and a pair of prongs at a first end of the elongated body, wherein the prongs are configured to release a first solar connector from a second solar connector. The solar wrench includes an open-ended wrench at a second end of the elongated body opposite the first end, wherein the open-ended wrench is configured to engage a first portion of the first solar connector. The solar wrench includes a slot passing through the elongated body and configured to allow a portion of the first solar connector to pass therethrough and engage a second portion of the first solar connector. The elongated body, the pair of prongs, and the open-ended wrench are formed of a metal material, and at least a portion of the metal material of the elongated body, the pair of prongs, and the open-ended wrench is covered by a plastic material.

In one feature, the first end of the elongated body is electrically insulated from the second end of the elongated body.

According to another feature, the plastic material is injection molded over a portion of the metal material.

As one feature, the plastic material comprises a first layer of plastic material injection molded over a portion of the metal material and a second layer of plastic material injection molded over a portion of the first layer of plastic material.

In one feature, a portion of the open-ended wrench is not covered by the plastic material.

According to one feature, the solar connector comprises an MC4 connector.

In one feature, the first end of the elongated body has a second pair of prongs configured to engage the first solar connector to release the first solar connector from a second solar connector, wherein the pair of prongs are orthogonal to the second pair of prongs.

In accordance with one feature, a solar wrench includes a first metal body having a pair of prongs. The prongs are configured to engage a first MC4 connector to release the first MC4 connector from a second MC4 connector. The solar wrench includes a second metal body having an open-ended wrench and a slot passing through the second metal body, wherein the open-ended wrench is configured to engage a first portion of the first MC4 connector and the slot is configured to engage a second portion of the first MC4 connector. The solar wrench includes a plastic layer covering a portion of the first metal body and the second metal body, wherein the plastic lay connects the first metal body to the second metal body.

According to another feature, the first metal body is electrically insulated from the second metal body.

As one feature, the plastic layer is injection molded over the first metal body and the second metal body.

In one feature, the solar wrench includes a second plastic layer injection molded over a portion of the plastic layer.

In one feature, a second portion of the open-ended wrench is not covered by the plastic layer.

According to another feature, the plastic layer has a thickness of at least 0.064 inches.

As one feature, the first metal body is unitarily formed with the second metal body.

It should be understood that the inventive concepts disclosed herein do not require each of the features discussed above, may include any combination of the features discussed, and may include features not specifically discussed above.

### BRIEF DESCRIPTION OF THE DRAWINGS

FIG. 1 is a perspective view from the front and side of a solar wrench.

FIG. 2 is a top view of the solar wrench of FIG. 1.

FIG. 3 is a bottom view of the solar wrench of FIG. 1.

FIG. 4 is a section view taken along line 2-2 of FIG. 2.

FIG. 5 is section view taken along line 4-4 of FIG. 4.

### DETAILED DESCRIPTION OF PREFERRED EMBODIMENTS

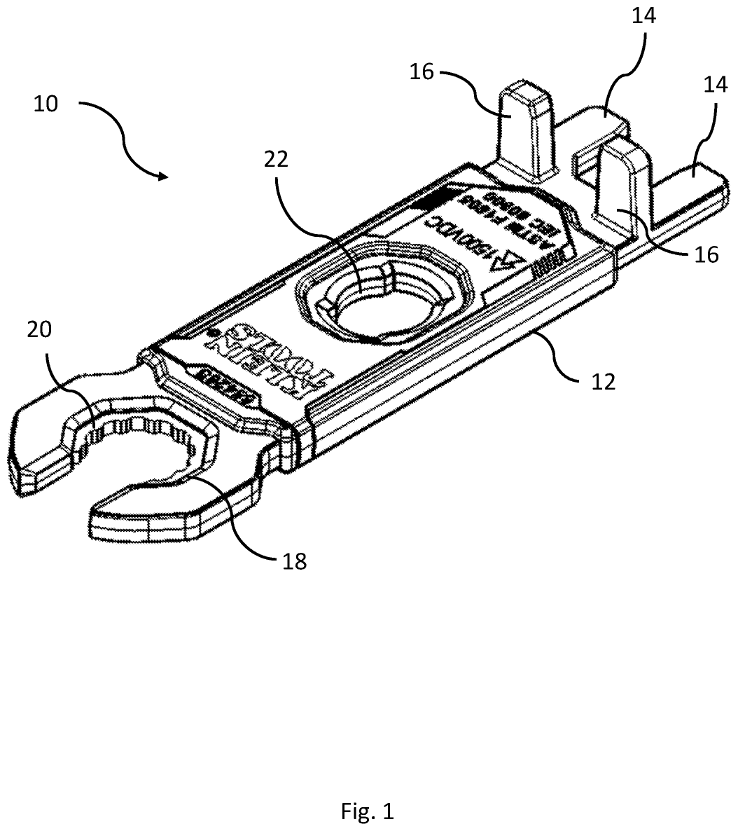

As shown in FIG. 1, an insulated solar wrench 10 (e.g., solar tool, solar connector tool, MC4 brand connector wrench, MC4 brand connector tool) is provided. As best shown in FIGS. 1-3, in the illustrated and preferred embodiment, the solar wrench 10 includes an elongated body 12 having a first pair of prongs 14 and a second pair of prongs 16 extending outwardly from a first end of the elongated body 12. In the illustrated and preferred embodiment, the first pair of prongs 14 extend in substantially the same direction (e.g., extend along a same axis) as the length of the elongated body 12, and the second pair of pongs 16 extend substantially perpendicular to the first pair of prongs. The first pair of prongs 14 and the second pair of prongs 16 are sized such that they may be received by a solar connector, such as an MC4 connector, to release a male end of the solar connector from a female solar connector.

In the illustrated and preferred embodiment, the solar wrench 10 includes an open-ended wrench 18 at a second end of the elongated body 12. The open-ended wrench 18 includes a plurality of teeth 20 along the interior of the open-ended wrench 18. In the illustrated and preferred embodiment, the open-ended wrench 18 and the plurality of teeth 20 are sized to engage a body (e.g., endcap) of a solar connector such as an MC4 connector, for example, to tighten or loosen the solar connector during installation. Solar connectors, such as MC4 connectors, are often formed by two pieces (e.g., of two-piece construction). The two pieces of a solar connector are assembled to install a single solar connector onto the end of a cable. For example, a user may thread together the two pieces of a male solar connector to install the male solar connector on the end of a cable. In the illustrated and preferred embodiment, the open-ended wrench 18 is sized such that the teeth 20 grip one of the two pieces of the solar connector.

In the illustrated and preferred embodiment, the solar wrench 10 includes a slot 22 (e.g., through slot, wrench slot) passing through the elongated body 12. The slot 22 is sized to engage the body of a solar connector. As discussed above, solar connectors are formed of two pieces which may be screwed together during installation. In the illustrated and preferred embodiment, a pair of solar wrenches 10 are used to install a male or female solar connector to a cable, with the open-ended wrench 18 engaging one piece of the solar connector and the slot 22 engaging another piece of the solar connector to screw the two pieces of the solar connector together.

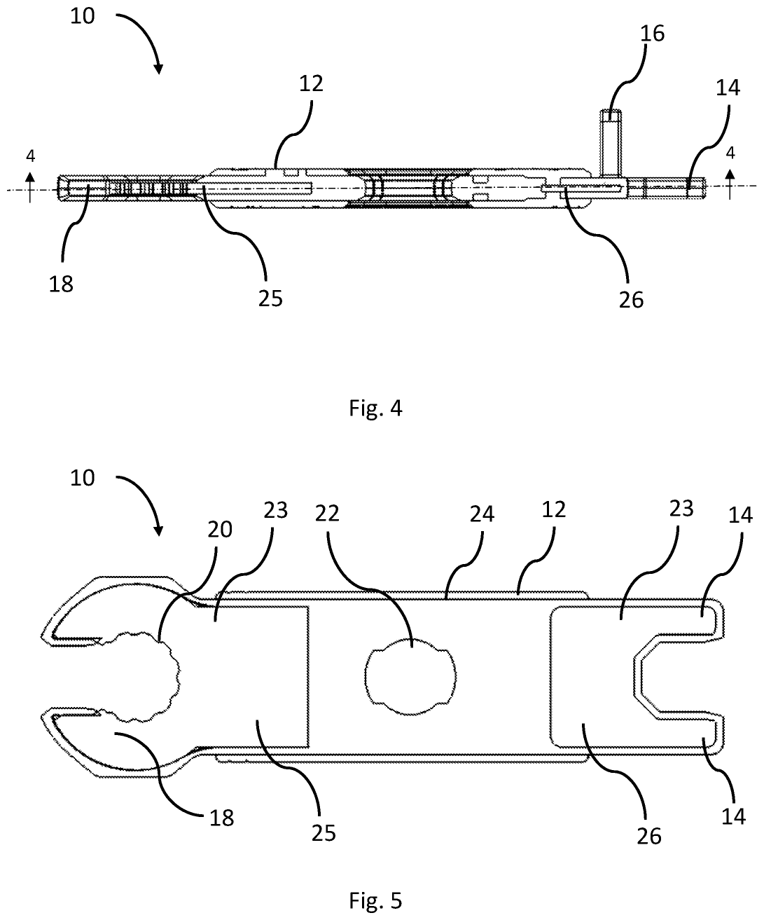

As best shown in FIGS. 4-5, in the illustrated and preferred embodiment, at least a portion of the solar wrench 10 comprises a metal material and a non-conductive material (e.g., non-conductive plastic). The use of a metal core 23 to form the solar wrench 10 increases the strength of the solar wrench 10. In the illustrated and preferred embodiment, the teeth 20 of the open-ended wrench 18 are formed of metal. While in some examples the teeth 20 may be formed of plastic, plastic may wear down with use, decreasing the ability of the teeth to grip a solar connector. The use of metal materials increases durability of the teeth. Further, the metal core 23 may be used along a length of at least a portion of the elongated body 12, providing increased strength and rigidity to the solar wrench 10. While plastic material may also be used to form the first pair of prongs 14, in the illustrated and preferred embodiment, the first pair of prongs comprise a core (e.g., interior) formed of a metallic (e.g., metal) material. The metallic material provides increased strength and durability, advantageously providing increased durability.

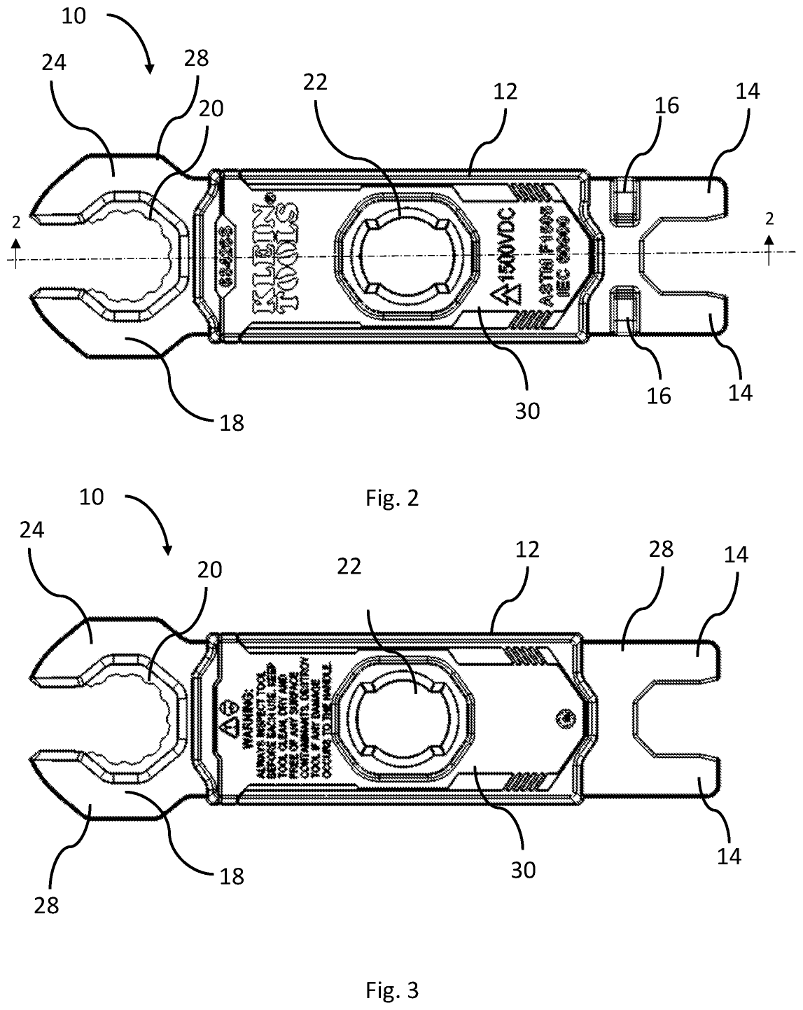

As discussed above, the use of metal to form the interior of the solar wrench 10 provides increased strength and durability. However, metallic materials are conductive and may increase risk to a user while working on live power lines. In the illustrated and preferred embodiment, the metal interior of the solar wrench 10 is covered by an insulating material 24 (e.g., non-conductive plastic). As best shown in FIG. 2, the open-ended wrench 18 is covered in insulating material 24 with the teeth 20 exposed. The exposed metallic teeth 20 provide increased durability and the insulating material 24 prevents electricity conducted by the teeth 20 from passing to the user.

In the illustrated and preferred embodiment, the metal interior of the open-ended wrench 18 is electrically isolated from the metal interior of the first pair of prongs 14. As best shown in FIG. 5, at least a portion of the length of the elongated body 12 is made of insulating material (e.g., plastic) to electrically isolate the open-ended wrench 18 from the first pair of prongs 14. In the illustrated and preferred embodiment, the open-ended wrench 18 includes a metal interior formed from a first metal portion 25 (e.g., first metal body) and the first pair of prongs 14 includes a metal interior formed from a second metal portion 26 (e.g., second metal body). A non-conductive material (e.g., plastic) is injection molded (e.g., over molded) over the first metal portion 25 and second metal portion 26. In the illustrated and preferred embodiment, the injection molded conductive material covers at least a portion of the open-ended wrench 18 and the first pair of prongs 14. As best shown in FIGS. 2-3, the non-conductive material forms the slot 22. In the illustrated and preferred embodiment, the solar wrench 10 comprises two layers of non-conductive material. A first layer 28 of non-conductive material (e.g., plastic) is molded over a majority of the solar wrench 10 (e.g., including the open-ended wrench 18, first pair of prongs 14, and second pair of prongs 16) and a second layer 30 of non-conductive material is formed over the first layer 28 of non-conductive material. In the illustrated and preferred embodiment, the second layer 30 of the non-conductive material covers a length of the elongated body. In the illustrated and preferred embodiment, at least a portion of the non-conductive material is at least 0.064 inches thick.

Preferred embodiments of the inventive concepts are described herein, including the best mode known to the inventor(s) for carrying out the inventive concepts. Variations of those preferred embodiments will become apparent to those of ordinary skill in the art upon reading the foregoing description. The inventor(s) expect skilled artisans to employ such variations as appropriate, and the inventor(s) intend that the inventive concepts can be practiced otherwise than as specifically described herein. Accordingly, the inventive concepts disclosed herein include all modifications and equivalents of the subject matter recited in the claims appended hereto as permitted by applicable law. Moreover, any combination of the above-described elements and features in all possible variations thereof is encompassed by the inventive concepts unless otherwise indicated herein or otherwise clearly contradicted by context. Further in this regard, while highly preferred forms of the solar wrench 10 are shown in the figures, it should be understood that this disclosure anticipates variations in the specific details of each of the disclosed components and features of the material dispenser and that no limitation to a specific form, configuration, or detail is intended unless expressly and specifically recited in an appended claim.

For example, while specific and preferred forms have been shown for the solar wrench 10 to include at least two metallic portions (e.g., the first metal portion 25 and second metal portion 26), the solar wrench 10 may comprise a single metallic portion. For example, the open-ended wrench 18 may comprise a metal interior (e.g., the first metal portion 25) and the first pair of prongs 14 may be formed entirely of non-metallic materials (e.g., plastic, non-conductive material, etc.). As another example, the first pair of prongs 14 may comprise a metal interior (e.g., the second metal portion 26) and the open-ended wrench 18 may be formed entirely of non-metallic materials (e.g., plastic, non-conductive material, etc.). In some examples the first metal portion 25 and second metal portion 26 may be a unitary piece and may not be electrically insulated from each other.

As another example, while a solar wrench 10 is shown including two metal portions (e.g., first metal portion 25 and second metal portion 26), in some examples the solar wrench 10 may include more than two metal portions. For example, the slot 22 may be formed of a third metal portion.

As a further example, while the first pair of prongs 14 are shown as comprising a metal interior, in some examples, the second pair of prongs 16 may include a metal interior. In some examples, the second metal portion 26 comprises the first pair of prongs 14 and the second pair of prongs 16. In some examples the first pair of prongs 14 comprise a plastic interior and the second pair of prongs 16 comprise a metal interior. In some examples the second metal portion 26 comprises the first pair of prongs and a different metal portion (not shown) comprises the second pair of prongs 16.

As a further example, while the solar wrench 10 of the illustrated and preferred embodiment is sized to work with MC4 style connector, the solar wrench 10 may be used with alternate solar connectors made in a similar style to MC4 connectors. In some examples, the size of the first pair of prongs 14 and/or the open-ended wrench 18 may be changed for use with solar connectors other than MC4 style connectors.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the inventive concepts disclosed herein and does not pose a limitation on the scope of any invention unless expressly claimed. No language in the specification should be construed as indicating any non-claimed element as essential to the practice of the inventive concepts disclosed herein.

What is claimed is:

1. An insulated solar wrench comprising:
an elongated body;
a pair of prongs at a first end of the elongated body, wherein the prongs are configured to release a first solar connector from a second solar connector;
an open-ended wrench at a second end of the elongated body opposite the first end, wherein the open-ended wrench is configured to engage a first portion of the first solar connector; and
a slot passing through the elongated body and configured to allow a portion of the first solar connector to pass therethrough and engage a second portion of the first solar connector;
wherein the elongated body, the pair of prongs, and the open-ended wrench are formed of a metal material; and
wherein at least a portion of the metal material of the elongated body, the pair of prongs, and the open-ended wrench is covered by a plastic material.

2. The tool of claim 1, wherein first end of the elongated body is electrically insulated from the second end of the elongated body.

3. The tool of claim 1, wherein the plastic material is injection molded over a portion of the metal material.

4. The tool of claim 1, wherein the plastic material comprises a first layer of plastic material injection molded over a portion of the metal material and a second layer of plastic material injection molded over a portion of the first layer of plastic material.

5. The tool of claim 1, wherein a portion of the open-ended wrench is not covered by the plastic material.

6. The tool of claim 1, wherein the first solar connector comprises an MC4 connector.

7. The tool of claim 1, wherein:
the first end of the elongated body has a second pair of prongs configured to engage the first solar connector to release the first solar connector from a second MC4 connector;
wherein the pair of prongs are orthogonal to the second pair of prongs.

8. A solar wrench comprising:
a first metal body having a pair of prongs, wherein the prongs are configured to engage a first MC4 connector to release the first MC4 connector from a second MC4 connector; and
a second metal body having an open-ended wrench and a slot passing through the second metal body, wherein the open-ended wrench is configured to engage a first portion of the first MC4 connector and the slot is configured to engage a second portion of the first MC4 connector; and
a plastic layer covering a portion of the first metal body and the second metal body;
wherein the plastic layer connects the first metal body to the second metal body.

9. The tool of claim 8, wherein the first metal body is electrically insulated from the second metal body.

10. The tool of claim 8, wherein the plastic layer is injection molded over the first metal body and the second metal body.

11. The tool of claim 10, further comprising a second plastic layer injection molded over a portion of the plastic layer.

12. The tool of claim 8, wherein a second portion of the open-ended wrench is not covered by the plastic layer.

13. The tool of claim 8, wherein the plastic layer has a thickness of at least 0.064 inches.

14. The tool of claim 8, wherein the first metal body is unitarily formed with the second metal body.

15. A tool comprising:
an elongated body;
wherein a first end of the elongated body has a pair of prongs configured to engage a first MC4 connector to release the first MC4 connector from a second MC4 connector; and
wherein a second end of the elongated body has an open-ended wrench;
a slot passing through the elongated body;
wherein the open-ended wrench is configured to engage a first portion of the first MC4 connector and the slot is configured to engage a second portion of the first MC4 connector; and
wherein the first end of the elongated body is electronically isolated from the second end of the elongated body.

16. The tool of claim 15, wherein the elongated body is made of a nonconductive material.

17. The tool of claim 15, wherein:
the elongated body is made of a conductive material; and
the elongated body is covered by a nonconductive material.

18. The tool of claim 17, wherein the nonconductive material is injection molded over the conductive material.

19. The tool of claim 17, wherein a portion of the open-ended wrench is not covered by the nonconductive material.

20. The tool of claim 16, wherein:
the first end of the elongated body has a second pair of prongs configured to engage the first MC4 connector to release the first MC4 connector from a second MC4 connector;
wherein the pair of prongs are orthogonal to the second pair of prongs.
